(19) United States
(12) Patent Application Publication
(10) Pub. No.: US 2004/0064563 A1
(43) Pub. Date: Apr. 1, 2004

(54) Change of bandwidth in a cellular communications system

(76) Inventors: Timo Heikki Kauhanen, Espoo (FI); Juha Rasanen, Espoo (FI); Harri Honko, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/362,826

(22) PCT Filed: Aug. 30, 2001
(86) PCT No.: PCT/IB01/01848

(30) Foreign Application Priority Data
Aug. 31, 2000 (GB) 0021441.1

(51) Int. Cl. G06F 15/16

(52) U.S. Cl. 709/227

(57) ABSTRACT

A method of negotiating a reconfiguration of a communication link in a communications system, the communications link carrying a communication connection between a first network element and an interim network element for transfer of data between the first network element and a second network element via the interim network element, the method comprising the steps of: determining a requirement for a reconfiguration of the link to a state in which it has a new characteristic; initiating negotiation between the first network element and the interim network element for reconfiguration of the link, in response to the initiation of negotiation, triggering a communication between the first network element and the second network element to determine whether the first network element and the second network element accept the connection between them over a link having the new characteristic, and in dependence on that communication accepting or rejecting the reconfiguration; and if the reconfiguration is accepted, performing the reconfiguration of the link.

This invention relates to changes of bandwidth in data transmission systems, and especially to a means of providing data transmission or reception applications with information on changes of bandwidth over a link between them. Preferred aspects of the invention are particularly suitable for implementation in wireless data transmission systems such as GSM (Global System for Mobile Communications) and UMTS (Universal Mobile Telecommunication System).

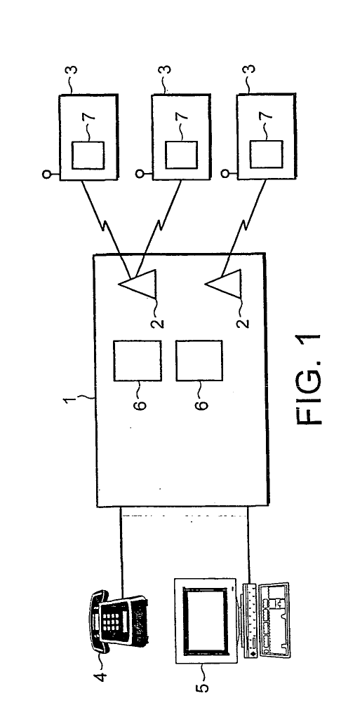

FIG. 1 shows a radio telecommunications system, such as a GSM or UMTS system. The system comprises a radio telecommunications network 1 including a plurality of base station transmission/reception units 2 which are capable of communicating by radio with user equipment 3. The user equipment could, for instance, be mobile stations such as mobile phones. By means of the network the UEs can communicate with each other or with other equipment such as land-line phone 4 or internet terminal 5 interconnected to the network 1. The network includes network data transmission/reception control units 6 which control the transmission and reception of data to an from the UEs according to a predetermined protocol. Correspondingly, the UEs include UE data transmission/reception control units 7 which control the transmission and reception of data to an from the network according to the predetermined protocol.

Connections between a UE and the network or another terminal may carry voice data or other forms of data.

Connections between a UE and the network or another terminal may be packet switched or circuit switched. When a circuit switched connection is in use an assumption may be made by data transmission or reception applications on the UE, the network or the other terminal that a constant bandwidth is available for communications. However, due to the circumstances of the radio telecommunications system variations in bandwidth may occur.

Variations in bandwidth may occur due to handover, for example. The base station transmission/reception units 2 and the UE 3 have limited range. When a UE in the course of a call moves from the zone of one base station transmission/reception units to the zone of another the network arranges for the UE to hand over from communicating with the first base station transmission/reception unit to the second. There may be a difference in the channel (bearer) characteristics between communication with the first base station transmission/reception unit and the other. For instance, the traffic densities and/or total traffic capacities at the base station transmission/reception units may differ; or they may operate on different systems (e.g. UMTS or GSM); or radio conditions such as the level of interference may impose different bandwidths before and after handover.

Applications using the radio link for transmission of data may be capable of adapting their operation in dependence on the available bandwidth over the link. For example H.324 (multimedia call) applications may be capable of varying the amount of data they transmit so as to match the available bandwidth.

Such applications reside at a different level in the protocol hierarchy from the processing that is aware of the bandwidth that is available over the bearer. There is therefore a need for a means of informing such applications of the available bandwidth or of changes in the available bandwidth.

For example, in the GSM system downgrading initiated by the network occurs at a lower layer (using the RR-procedure CHANNEL_MODE_MODIFY) and does not involve the Call Control layer. It is possible for an application/user to indirectly, by ‘sensing’ the delivered quality of service, be informed of the service level, which may be tolerable or not tolerable. However, this requires unorthodox procedures to be used. An explicit signalling of the bandwidth or service level would be greatly preferred and would offer greatly enhanced compatibility with applications.

According to the present invention from one aspect there is provided a method of negotiating a reconfiguration of a communication link in a communications system, the communications link carrying a communication connection between a first network element and an interim network element for transfer of data between the first network element and a second network element via the interim network element, the method comprising the steps of:

determining a requirement for a reconfiguration of the link to a state in which it has a new characteristic;

initiating negotiation between the first network element and the interim network element for reconfiguration of the link,

in response to the initiation of negotiation, triggering a communication between the first network element and the second network element to determine whether the first network element and the second network element accept the connection between them over a link having the new characteristic, and in dependence on that communication accepting or rejecting the reconfiguration; and

if the reconfiguration is accepted, performing the reconfiguration of the link.

According to the present invention from a second aspect there is provided a telecommunications system for supporting a communications link carrying a communication connection for transfer of data between a first network element and a second network element via an interim network element, the system comprising a control unit for determining a requirement for a reconfiguration of the link between the first network element and the interim network element to a state in which it has a new characteristic and negotiation means for negotiating the reconfiguration of the link between the first network element and the interim network element the first network element being adapted to, in response to receiving notification that such a negotiation has begun, trigger a communication with the second network element terminal to determine whether the the reconfigured link between the first network element and the second network element is acceptable for the connection between the first and the scond network element, and in dependence on that communication transmit an indication on the acceptance or rejection of the reconfiguration; and the system being adapted toperform the reconfiguration of the link if the reconfiguration is accepted.

According to the present invention from a third aspect there is provided a network element for a telecommunications system for supporting a communications link carrying a communication connection for transfer of data between the network element and a second network element via an interim network element, the system comprising a control unit for determining a requirement for a reconfiguration of the link between the network element and the interim network element to a state in which it has a new characteristic and negotiation means for negotiating the reconfiguration of the link between the network element and the interim network element; and the network element being adapted to, in response to receiving notification that such a negotiation has begun, trigger a communication with the second network element terminal to determine whether the reconfigured link between the network element and the second network element is acceptable for the connection between the and the second network element, and in dependence on that communication transmit an indication on the acceptance or rejection of the reconfiguration; the system being adapted to perform the reconfiguration of the link if the reconfiguration is-accepted.

One or both of the first and second network elements may be terminals.

Suitably, if the modification rejection message is sent to the network the connection is terminated.

The link suitably includes at least a portion carried by wireless means, such as radio or infra-red.

The reconfiguration may be a handover. For example, the reconfiguration may be a handover of a radio link between one of the terminals and a first base station transceiver of the network to a radio link between that one of the terminals and a second base station transceiver of the network. The base station transceivers may be operable according to the same or different network protocols/standards. The first base station transceiver may be operable according to a first network protocol and the second base station transceiver operable according to a second network protocol. One may be a GSM BTS and the other a UMTS BTS.

The terminals and the network are each preferably operable according to at least one of the GSM or UMTS network protocols or a derivative thereof.

The modification request message is most preferably in the form of a MODIFY message of a GSM and/or UMTS network or a derivative thereof. The modification acceptance message is most preferably in the form of a MODIFY_ACCEPT message of a GSM and/or UMTS network or a derivative thereof.

The said characteristic is suitably a characteristic indicative of available bandwidth over the link, for example a number of channels or a direct measure of bandwidth such as a measure in bits per second.

The step of communicating between the first terminal and the second terminal to determine whether the first terminal and the second terminal are capable of sustaining the connection between them over a link having the new characteristic is preferably performed at the service level. The communication may be between two applications operating on the terminals, for example between H.324 applications of the terminals. The data is preferably multimedia data. The connection is preferably a circuit switched connection.

The modification request message is preferably addressed to the service level of the first terminal.

The modification acceptance or modification rejection message is preferably sent from the first terminal. The or each terminal is preferably a GSM mobile station and/or a UMTS user equipment.

The present invention will now be described by way of example with reference to the accompanying drawings, in which:

FIG. 1 is a schematic diagram of a radio telecommunications system;

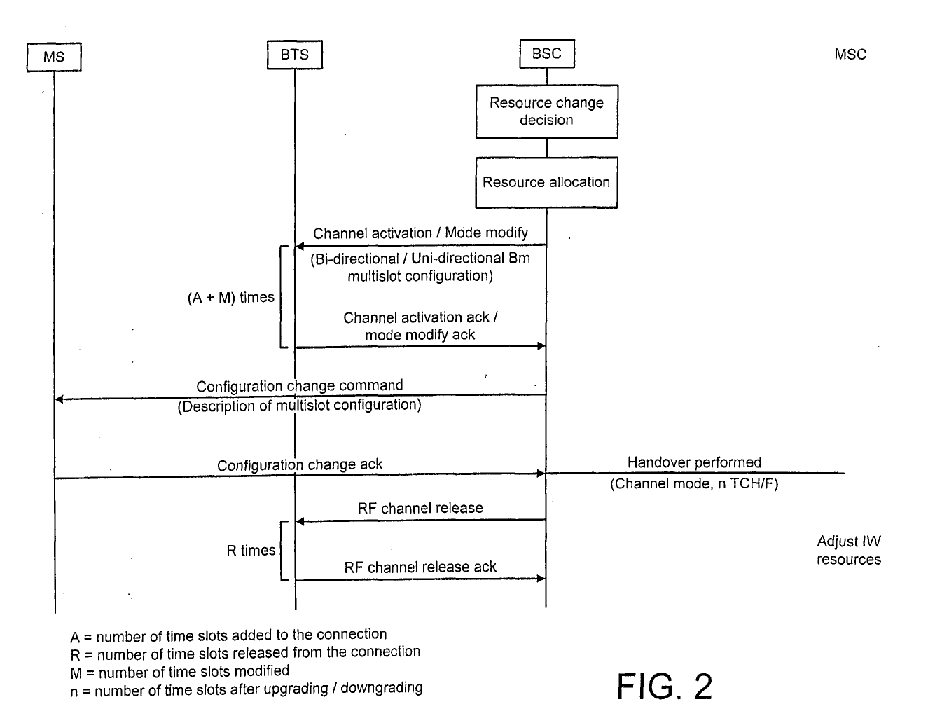

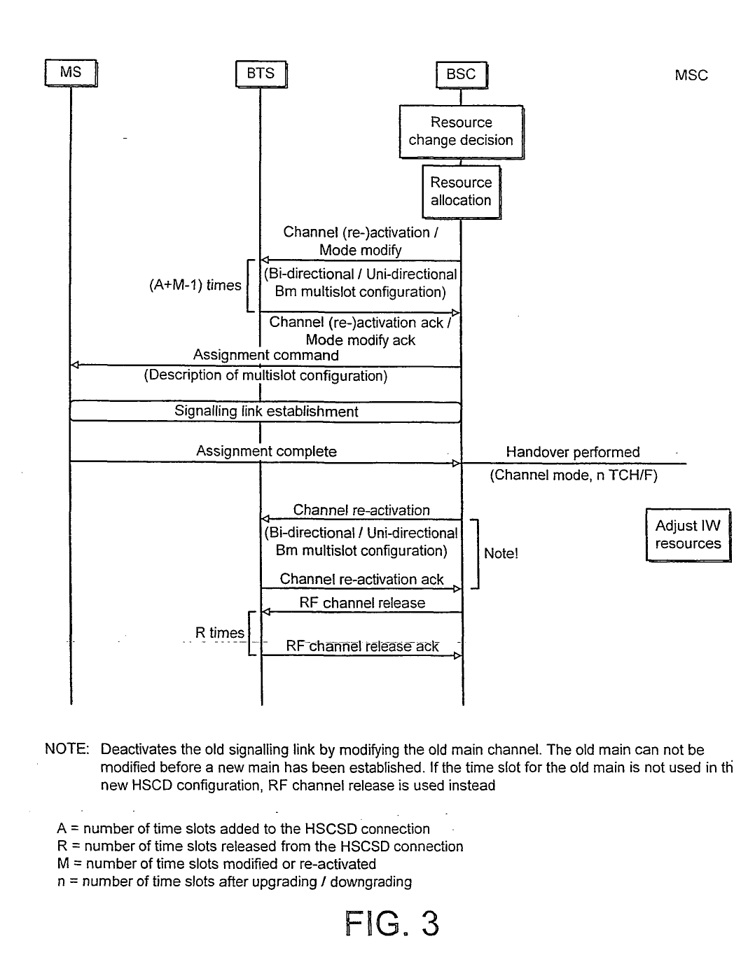

FIGS. 2 and 3 illustrate signalling scenarios for upgrading and downgrading of resources for an ongoing HSCSD call;

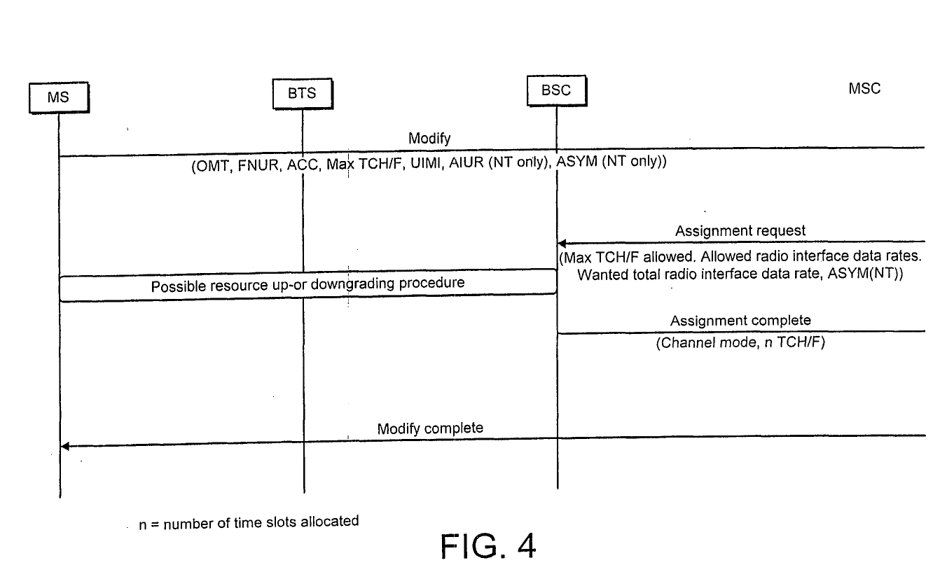

FIG. 4 illustrates signalling scenarios for a user initiated service level up and downgrading for an on-going HSCSD call; and

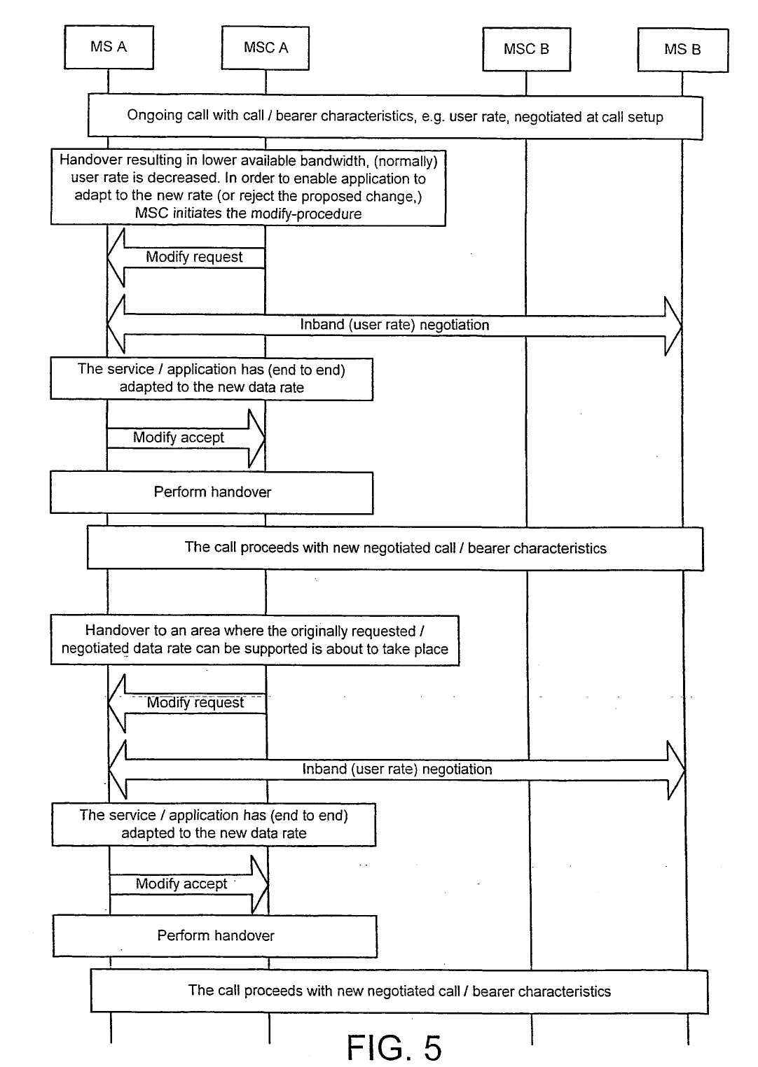

FIG. 5 illustrates a signalling scenario for a call with successful downgrading, succeeded by successful upgrading.

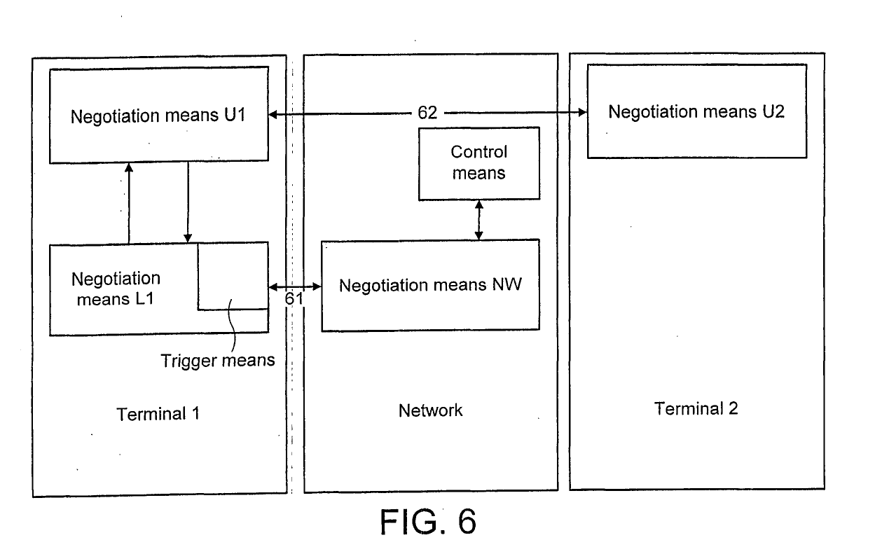

FIG. 6 illustrates a communication system according to the invention.

The present invention will be described with specific reference to circuit switched multimedia telephony in GSM and UMTS. However, it should be noted that the invention is not restricted to that application.

As described above, when data is being sent over a communications link for example a radio link events such as changes in link conditions (e.g. interference) or handover causing a move in the link from one set of conditions to another or from one telecommunications system to another (inter-system handover), the available bandwidth of an ongoing connection such as a multimedia call may change during the lifetime of the call. This imposes a change on the call (bearer) characteristics during the call.

In situations where a higher level application could usefully make use of knowledge of the changed link characteristics it would be valuable to be able to inform such an application or other user (e.g. the person using the device in question) of changes in available bandwidth. An example of a way in which this may be achieved will now be described.

The GSM and proposed UMTS systems provide a MODIFY-procedure, which, for example in the GSM system, is used in situations such as the negotiation of the number of multislot traffic channels, suitably in high speed circuit switched data (HSCSD).

The configuration of an HSCSD link can be modified by the allocation of more channels (resource upgrading) or the release of previously allocated channels (resource downgrading). Both of these procedures are initiated by the network. The procedures are used in non-transparent calls to alter the channel resources in the range from a single TCH/F (traffic channel/full rate) to the prevailing maximum permitted number of TCH/Fs allowed. In the case of transparent connections, resources can also be altered, provided that the AIUR (air interface user rate) for the connection remains constant.

FIG. 2 depicts the procedures for the successful upgrading and downgrading of resources for an ongoing HSCSD call, assuming the position of the main TCH/F remains unchanged.

As illustrated in FIG. 2, a separate channel activation for the new HSCSD channels is carried out and the earlier activated HSCSD channels may be modified, before the RR (radio resource) configuration change procedure is used to forward the new channel configuration to the mobile station. Similarly, the configuration change procedure can be used in both transparent and non-transparent calls for reordering the channels in a call without changing the number of TCH/Fs allocated. At the completion of resource modification, the BSC (base station controller) signals to the MSC (mobile switching centre) the new HSCSD configuration and the MSC may adjusts the IW (inter-working) resources accordingly.

In the signalling flow of FIG. 2, the BSC makes a decision to change the allocation of resources and then determines the new resource allocation. The BSC then sends a channel activation/mode modify signal to the BTS (base transceiver station), and the BTS responds with a channel activation acknowledgement/mode modify acknowledgement message. This is repeated once for each time slot that is added to the connection or modified. Then the BSC sends a configuration change command including a description of the new multislot configuration to the MS (mobile station) or UE, and the MS responds with a configuration change acknowledgement message. At that stage handover is performed and interworking resources adjusted by the MSC.

Correspondingly, to release channels the BSC sends the RF channel release message to the BTS and the BTS responds with the RF release channel acknowledgement message once for each time slot that is to be released from the connection.

FIG. 3 depicts the procedures for the successful resource upgrading and downgrading of resources for an ongoing HSCSD call, assuming the position of the main TCH/F is changed.

In this case a separate channel activation for the new HSCSD channels is carried out and the earlier activated HSCSD channels may be modified or, in case of the new main channel, reactivated, before the RR Assignment procedure is used for forwarding the new channel configuration to the mobile station. Similarly, the Assignment procedure can be used in both transparent and non-transparent calls for reordering the channels in a call without changing the number of TCH/Fs allocated.

The signalling flow of FIG. 3 is similar to that of FIG. 2. In the system of FIG. 3, one fewer set of channel activation and acknowledgement messages is sent. An assignment command from the BSC to the MS is followed by establishment of a signalling link between the two, and an assignment complete signal from the MS to the BSC. Then the position of the main TCH/F is changed by a final pair of channel activation and acknowledgement messages.

In each case, at the completion of resource modification, the BSC signals the new HSCSD configuration to the MSC and the MSC may adjusts the IW resources accordingly.

FIG. 4 depicts the procedures for a successful user initiated service level up and downgrading for on-going HSCSD call.

During an HSCSD call the user may request, if so indicated in the call setup, the network to change the current maximum number of traffic channels and air interface user rate parameters and/or channel coding asymmetry preference. This is done by using the CC User initiated service level up- and downgrading procedure.

If the network permits the modification, the resulting new parameters are forwarded to BSC and the radio interface resources may be adjusted accordingly. The resource upgrading or downgrading is performed separately from the change in HSCSD parameters. However, if there is a conflict between the new parameters and the used air interface resources, resource downgrading may be needed before the network acknowledges the new parameters.

User-initiated service level up- and downgrading is applicable only in non-transparent mode connections.

Since the procedure described above is only applicable for user-initiated negotiation, it does not permit network-initiated negotiation, which is needed to address the issue of informing applications and other users of changes in the available bandwidth.

A method for explicit signaling of available bandwidth etc. to applications and users will now be described.

When the core network, which could, for example be a GSM or UMTS network, has determined the need for a change (e.g. a handover or other change of link parameters) the (CC-) message MODIFY is sent to the mobile station. The relevant terminal/application at the mobile (e.g. H.324 in a circuit-switched multimedia call) may then start a negotiation (either inband or outband) of new characteristics with its peer at the other end of the link. Such a negotiation may be of the data rate and optionally other parameters too. If the negotiation is successful, and the application/user accepts the new call characteristics the mobile station responds to the core network with a MODIFY_ACCEPT-message.

In case of TDM transmission in the core network, the MSC IWF (interworking function) or the MSC MGW (server and media gateway) performs a rate adaptation between the downgraded mobile traffic channel and the broader fixed network traffic channel. This may be done, for example by flag stuffing (i.e. the insertion of extra flags between frames to fill the broader channel, or the discard of extra flags when forwarding the data from the broader channel to the downgraded channel). In the case of packet transmission (e.g. IP (internet protocol) based or ATM (asynchronous transfer mode)) in the core network, the required bit rate in the core medium may be renegotiated to comply with the new end-to-end data rate.

If the change is not acceptable to the mobile station it responds with a MODIFY_REJECT-message.

In the case of handover the procedure described above will be performed before the handover takes place; preferably immediately the decision to perform handover has been made. The time required for the end to end negotiation between the MS and its peer is likely to be of the order of one second which, even when added to the preparation time before handover, leaves the risk of losing the call minimal.

FIG. 5 illustrates signaling for a call where successful downgrading is followed by successful upgrading.

In the scenario of the upper half of FIG. 5, initially an ongoing call between MS A and MS B exists via MSC A and MSC B. The call has determinate characteristics such as user rate. The characteristics of the call were negotiated at call set up. Subsequently a handover of the call (in this illustration a handover involving MS A) occurs resulting in a lower available bandwidth. In order to allow higher level applications to adapt to the new rate or to try to reject the proposed change if that is permitted by the network the MSC responsible for the call initiates a modify procedure.

The modify procedure begins with a modify request sent from the MSC (MSC A) to MS A. The modify request specifies the relevant characteristics of the new link following the modification proposed by the MSC. In response, the MS A initiates an inband process of user rate negotiation between itself and MS B to determine whether the transfer of data between them can be adapted to the proposed new data rate. Assuming that such adaptation is possible, the MS A returns a modify accept message to the MSC A and the handover is performed, adapting the link to the proposed conditions, and the call proceeds. If the adaptation is not possible, the MS A would returnsa modify reject message and the MSC would then determine whether To respect the MSs' rejection of the new link and make the handover regardless, or to cancel the handover operation.

In addition to service downgrading, described above, the method described above may be applied to service upgrading, i.e. the case where a call has been downgraded, but originally-requested resources become available later during the call (for example due to handover). Apart from the altered ‘direction’ of the change, the signaling is analogous to the downgrading case.

As shown in the lower half of FIG. 5, a similar procedure can be followed if the handover would result in the same or even increased bandwidth compared to that of the preexisting call.

The procedure of FIG. 5 can, in GSM and UMTS systems, make use of an adaptation of the currently existing in-call modification procedure (MODIFY and MODIFY_ACCEPT message), using those existing messages in a new situation and for a new purpose.

The above method may be implemented in terminal equipment (UE or MS) for theUMTS and/or GSM systems and/or derivatives thereof. Preferably the terminals in question support circuit switched multimedia, since in that setting the method provides particular advantages. Circuit switched multimedia applications may be particularly sensitive to changes in available bandwidth, but may also have the capacity to modify their operation to adapt to the bandwidth available. Network elements such as the MSC IWF or MSC server and MGW (mobile gateway) may suitable be adapted to support the method.

FIG. 6 illustrates a telecommunications system according to the invention. The system supports a communications link 61 carrying a communication connection for transfer of data 62 between a first network element such as a mobile terminal and a second network element such as a network server via an interim network element, such as an interworking unit (IWF) of the mobile services switching center MSC. The system also comprises a control unit for determining a requirement for a reconfiguration of the link between the first network element and the interim network element to a state in which it has a new characteristic. When the need for the reconfiguration arises, the negotiation means NW in or connected to the interim network element and the negotiation means L1 in the mobile terminal begin a negotiation. In response to having begun such a negotiation, to the mobile terminal triggers with a trigger a communication with the server using negotiation means U1 and U2 to determine whether the reconfigured link between the mobile terminal and the MSC is acceptable for the connection between the mobile terminal and the server. In dependence on the result of that communication, the mobile terminal either accepts or rejects the reconfiguration using its negotiation means L1. If the mobile terminal accepts the reconfiguration, the reconfiguration is performed.

A major advantage of the method is that the application/user is explicitly notified of an intended change of service level. This enables the application/user to perform an end to end (inband) negotiation to adapt to the new call characteristics. The application/user may also approve or reject the proposed attributes. If the proposed link attributes are rejected then the call could be forcibly disconnected, indirectly disconnected by forcing the change in bandwidth, or a decision may be taken by the network not to make the change or to reallocate resources to as to allow more bandwidth to the link after the change.

Instead of or in addition to bandwidth, the present method may be applied to negotiation of other link parameters such as delay.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method of negotiating a reconfiguration of a communication link in a communications system, the communications link carrying a communication connection between a first network element and an interim network element for transfer of data between the first network element and a second network element via the interim network element, the method comprising the steps of:
determining a requirement for a reconfiguration of the link to a state in which it has a new characteristic;
initiating negotiation between the first network element and the interim network element for reconfiguration of the link,
in response to the initiation of negotiation, triggering a communication between the first network element and the second network element to determine whether the first network element and the second network element accept the connection between them over a link having the new characteristic, and in dependence on that communication accepting or rejecting the reconfiguration; and
if the reconfiguration is accepted, performing the reconfiguration of the link.

2. A method as claimed in claim 1, wherein at least one of the first and the second network elements is a terminal.

3. A method as claimed in claim 1 or 2, wherein if the reconfiguration is rejected the connection is terminated.

4. A method as claimed in any preceding claim, wherein the link includes at least a portion carried by wireless means.

5. A method as claimed in claim 4, wherein the said portion is carried by radio.

6. A method as claimed in any preceding claim, wherein the reconfiguration is a handover.

7. A method as claimed in claim 6 as dependant on claim 5, wherein the reconfiguration is a handover of a radio link between one of the first and second network elements and a first base station transceiver of the network to a radio link between that one of the first and second network elements and a second base station transceiver of the network.

8. A method as claimed in claim 7, wherein the first base station transceiver is operable according to a first network protocol and the second base station transceiver is operable according to a second network protocol.

9. A method as claimed in any preceding claim, wherein the first and second network elements and the network are each operable according to at least one of the GSM or UMTS network protocols or a derivative thereof.

10. A method as claimed in any preceding claim, wherein said initiation of negotiation is in the form of a modification request message and wherein accepting or rejecting said communication triggered in response to said initiation of negotiation is in the form of a corresponding modification acceptance message or a modification rejection message respectively.

11. A method as claimed in claim 10, wherein the modification request message is in the form of a MODIFY message of a GSM and/or UMTS network or a derivative thereof.

12. A method as claimed in claim 10 or 11, wherein the modification acceptance message is in the form of a MODIFY_ACCEPT message of a GSM and/or UMTS network or a derivative thereof.

13. A method as claimed in any preceding claim, wherein the characteristic is a characteristic indicative of available bandwidth over the link.

14. A method as claimed in claim 13, wherein the characteristic is a number of channels.

15. A method as claimed in any preceding claim, wherein the step of communicating between the first network element and the second network element to determine whether the first network element and the second network element are capable of sustaining the connection between them over a link having the new characteristic is performed at the service level.

16. A method as claimed in any preceding claim, wherein the modification request message is addressed to the service level of the first network element.

17. A method as claimed in any preceding claim, wherein the modification acceptance or modification rejection message is sent from the first network element.

18. A method as claimed in any preceding claim, wherein each of the network elements is a GSM mobile station and/or a UMTS user equipment.

19. A method substantially as herein described with reference to FIG. 5 or 6.

20. A telecommunications system for supporting a communications link carrying a communication connection for transfer of data between a first network element and a second network element via an interim network element,
the system comprising a control unit for determining a requirement for a reconfiguration of the link between the first network element and the interim network element to a state in which it has a new characteristic and negotiation means for negotiating the reconfiguration of the link between the first network element and the interim network element;
the first network element being adapted to, in response to receiving notification that such a negotiation has begun, trigger a communication with the second network element terminal to determine whether the reconfigured link between the first network element and the second network element is acceptable for the connection between the first and the second network element, and in dependence on that communication transmit an indication on the acceptance or rejection of the reconfiguration; and
the system being adapted to perform the reconfiguration of the link if the reconfiguration is accepted.

21. A network element for a telecommunications system for supporting a communications link carrying a communication connection for transfer of data between the network element and a second network element via an interim network element,
the system comprising a control unit for determining a requirement for a reconfiguration of the link between the network element and the interim network element to a state in which it has a new characteristic and negotiation means for negotiating the reconfiguration of the link between the network element and the interim network element; and
the network element being adapted to, in response to receiving notification that such a negotiation has begun, trigger a communication with the second network element terminal to determine whether the reconfigured link between the network element and the second network element is acceptable for the connection between the and the second network element, and in dependence on that communication transmit an indication on the acceptance or rejection of the reconfiguration; the system being adapted to perform the reconfiguration of the link if the reconfiguration is accepted.
